(19) United States
(12) Patent Application Publication
(10) Pub. No.: US 2025/0261278 A1
(43) Pub. Date: Aug. 14, 2025

(54) Beam Based Discontinuous Transmission/Reception for Non-Terrestrial Networks

(71) Applicant: Apple Inc., Cupertino, CA (US)

(72) Inventors: Chunxuan YE, San Diego, CA (US); Ankit BHAMRI, Haar (DE); Chunhai YAO, Beijing (CN); Dan WU, Beijing (CN); Dawei ZHANG, Saratoga, CA (US); Haitong SUN, Saratoga, CA (US); Hong HE, San Jose, CA (US); Wei ZENG, Saratoga, CA (US)

(21) Appl. No.: 19/052,797

(22) Filed: Feb. 13, 2025

Related U.S. Application Data
(60) Provisional application No. 63/552,785, filed on Feb. 13, 2024.

(51) Int. Cl. H04W 76/28; H04B 7/06

(52) U.S. Cl. CPC H04W 76/28; H04B 7/06952

(57) ABSTRACT

An apparatus configured to process, based on signals received from a network, beam based configuration information, where the beam based configuration information comprises configuration information for one or more individual beams received by a user equipment (UE) and operate in a discontinuous transmission (DTX) mode and/or a discontinuous reception (DRX) mode using the beam based configuration information.

### PRIORITY/INCORPORATION BY REFERENCE

This application claims priority to U.S. Provisional Application Ser. No. 63/552, 785 filed Feb. 13, 2025, and entitled, “Beam Based Discontinuous Transmission/Reception for Non-Terrestrial Networks,” the entirety of which is incorporated by reference herein.

### BACKGROUND

Network energy saving (NES) is a mode of operation for 5G New Radio (NR) which reduces signaling and power draw for the network. A NR network may support devices that use NES features. These types of features provide cost and/or complexity reduction benefits. However, the NES systems may still need to provide positioning and/or location services that may be impacted because of the network energy saving capabilities of the devices. For example, there are multiple mechanisms to reduce power consumption. Such mechanisms may enhance the user experience by not exhausting a battery of a user equipment (UE) at an inappropriate rate. One such mechanism is referred to as discontinuous reception or “DRX” and another mechanism is discontinuous transmission or “DTX.” These mechanisms may be implemented at either or both of the UE or network components (e.g., base stations). DRX and DTX are methods used in mobile communication to conserve power. For example, the UE and the network negotiate phases in which data transfer occurs. During other times the UE and base station may turn of their receivers and/or transmitters and enter a low power state. DTX/DRX may be used on the UE side for power saving purposes and may also be used on the network side for network energy savings.

Operations for providing system information (SI) currently cause the network to consume a large amount of power. System information blocks (SIBs) for a serving cell are transmitted by the serving cell itself. Up to 64 downlink (DL) beams may be deployed for Frequency Range 2 (FR2) operations and each DL beam transmits its own SIB information via beam sweeping, which causes a large amount of signaling overhead and power consumption. In another issue, uplink (UL) activity, particularly listening for random access (RACH) messages, may prevent the network from entering deep sleep states.

NES techniques were standardized in Release 18 (Rel-18) for spatial and power domain and cell discontinuous transmission/reception (DTX/DRX). Other techniques for additional network energy gains are being explored for Rel-19. In particular, downlink coverage enhancement (i.e., serving a larger area) has been proposed, especially for non-terrestrial networks (NTN), to leverage techniques for NES. This is especially important in NTN, since each satellite has limited power to transmit and a larger coverage area (e.g., hundreds or thousands of square miles). However, specific implementations to provide this enhanced downlink coverage do not yet exist.

Certain enhancements on cell based DTX/DRX mechanisms have been proposed. One potential issue that arises from these enhancements is that signals used for positioning may be affected by NES status, particularly with cell based DRX/DTX mechanisms. Thus, a mechanism is needed to be able to use NES systems that use DRX/DTX mechanisms to conserve power, while still providing improved and accurate positioning performance without wasting resources.

### SUMMARY

Some example embodiments are related to an apparatus having processing circuitry configured to process, based on signals received from a network, beam based configuration information, where the beam based configuration information comprises configuration information for one or more individual beams received by a user equipment (UE) and operate in a discontinuous transmission (DTX) mode and/or a discontinuous reception (DRX) mode using the beam based configuration information.

Other example embodiments are related to an apparatus having processing circuitry configured to process, based on signals received from a base station, configuration information comprising information indicating that one or more beams received by a user equipment (UE) is in a mode where system information blocks (SIBs) are not being transmitted (SIB-less mode), determine, based on a trigger, that SIB information is used and generate, for transmission to the base station, an uplink wake-up signal to request a SIB transmission.

Still further example embodiments are related to an apparatus having processing circuitry configured to determining that one or more beams configured to be received by a user equipment (UE) is in a mode where system information blocks (SIBs) are not being transmitted (SIB-less mode), generating, for broadcast, synchronization signal block (SSB) information in the one or more beams, processing, based on signals received from the UE, a wake-up indication for SIB transmission, the wake-up indication comprising a request for SIB information and generating, for transmission in a transmission mode based on the request, the requested SIB information.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example cell based DTX/DRX configuration according to various example embodiments.

FIG. 5 illustrates an example beam based DTX/DRX configuration according to various example embodiments.

FIG. 6 is an example flow diagram illustrating an example procedure for the UE to obtain beam DTX/DRX information according to various example embodiments.

FIG. 7A illustrates an example legacy downlink control information (DCI) format 2_9 according to various example embodiments.

FIG. 7B illustrates an example modified DCI format 2_9 using the proposed beam based DTX/DRX configuration according to various example embodiments.

FIG. 8 is an example flow diagram illustrating an example procedure for a UE in SIB-less operations in a NTN according to various example embodiments.

FIG. 9A illustrates an example configuration for a one-time configuration for SIB-less timing information according to various example embodiments.

FIG. 9B illustrates an example configuration for a periodic configuration for SIB-less timing information according to various example embodiments.

FIG. 10 illustrates a flow chart for an example procedure for a base station in SIB-less operations according to various example embodiments.

FIG. 11 shows an example non-terrestrial network (NTN) architecture according to various example embodiments.

### DETAILED DESCRIPTION

The example embodiments may be further understood with reference to the following description and the related appended drawings, wherein like elements are provided with the same reference numerals. The example embodiments relate to enhanced downlink coverage, particularly in NIN at the system level. In particular, it is proposed to modify the configurations to support beam based DTX/DRX. This includes techniques and procedures for the UE to obtain beam based DTX/DRX information. In addition, additional operations for the UE in beam or cell DTX and beam or cell DRX are proposed, e.g., the UE's exception of operations for sidelink related scheduling and reporting in beam/cell DTX duration or beam/cell DRX duration. Further, SIB-less operations in NTN may be possible, where SIBs are not transmitted. UE procedures in SIB-less operations in NTN and new configuration(s) for SIB-less operations are also proposed, as well as a wake-up signal for the UE to trigger the SIB transmission, including triggering conditions and signaling design, to provide recovery from energy savings operations.

The example embodiments are described with regard to a UE. However, reference to a UE is merely provided for illustrative purposes. The example embodiments may be utilized with any electronic component that may establish a connection to an accessory device and is configured with the hardware, software, and/or firmware to exchange information and data with accessory devices. Therefore, the UE as described herein is used to represent any electronic component.

The example embodiments are also described with reference to a 5G New Radio (NR) network. However, the example embodiments may also be implemented in other types of networks, including but not limited to LTE networks, future evolutions of the cellular protocol (e.g., 5G-advanced networks, 6G networks, etc.), or any other type of network.

The example embodiments are also described with reference to carrier aggregation (CA). In CA, a UE may communicate in the downlink (DL) or uplink (UL) with multiple cells of a network to increase throughput. CA includes the UE associating with a Primary Cell (PCell) and one or more Secondary Cells (SCells). Different band combinations of CA may be served by the PCell and SCell, e.g., the PCell may serve a first component carrier (CC) of a CA band combination (e.g., CC1) to the UE and the SCell may serve a second CC of the CA band combination (e.g., CC2) to the UE. Thus, in CA, both the PCell and the SCell are considered to be serving cells. CA mode may include multiple SCells. In the example embodiments, it may be considered that the PCell and SCell(s) are co-located, e.g., in the same general physical location (e.g., on the same cell tower). The PCell and the SCells may be cells of different gNBs or a single gNB. In the present embodiments, the PCell may be the anchor cell and the SCell(s) may be the eNES cell(s).

The example embodiments are also described with reference to system information (SI), in particular system information block 1 (SIB1), and the physical random access channel (PRACH). SIB1 may be broadcast by a cell for reception by a UE and may include parameters that are critical for operations including, e.g., initial access. Based on the parameters decoded from SIB1, the UE may transmit a RACH preamble on PRACH to attempt to access the cell. The UE may continue to monitor for SIB1 even after entering the connected state with the cell, e.g., to detect changes to SIB1 parameters such as, e.g., scheduling information, to adapt to changing network conditions. The PRACH configuration carried in SIB1 may also change after connection establishment. Although PRACH is typically transmitted as Msg1 of initial access, the PRACH may be used in other scenarios, e.g., handover or RACH after initial connection establishment. Accordingly, SIB1 may be transmitted periodically by the cell and decoded periodically by the UE even after entering the connected state. Some SIB1 transmissions may include a full set of SIB1 parameters while other SIB1 transmissions may include a subset of SIB1 parameters, e.g., those parameters that have changed since the last SIB1 transmission.

The example embodiments provide operations for a UE to receive beam base DTX/DRX configuration parameters. In addition, additional operations for the UE in beam or cell DTX and beam or cell DRX are proposed, e.g., the UE's exception of operations for sidelink related scheduling and reporting in beam/cell DTX duration or beam/cell DRX duration. Further, SIB-less operations in NIN may be possible, where SIBs are not transmitted to provide recovery from energy savings. UE procedures in SIB-less operations in NIN and new configuration(s) for SIB-less operations are proposed, as well as a wake-up signal for the UE to trigger the SIB transmission, including triggering conditions and signaling design. Each of these example embodiments will be described in greater detail below.

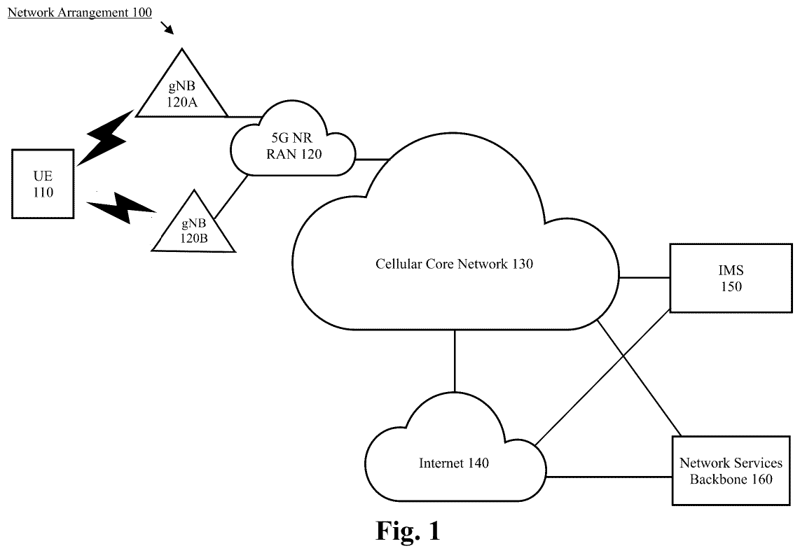

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a legacy cellular network, etc.) and the UE 110 may also communicate with networks over a wired connection. With regard to the example embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A and the gNB 120B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

In this example, it may be considered that the UE 110 is operating in CA mode where the gNB 120A is the PCell and the gNB 120B is the SCell that will be operating in enhanced network energy saving (eNES) mode(s). As described above, CA mode may include multiple SCells but for the purpose of description only a single SCell is shown. In the example embodiments, it may be considered that the PCell and SCell are co-located, e.g., in the same general physical location (e.g., on the same cell tower). Also, while the PCell and SCell are shown as being different gNBs, a single gNB may include multiple cells. Thus, the PCell and SCell may be cells of the same gNB.

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

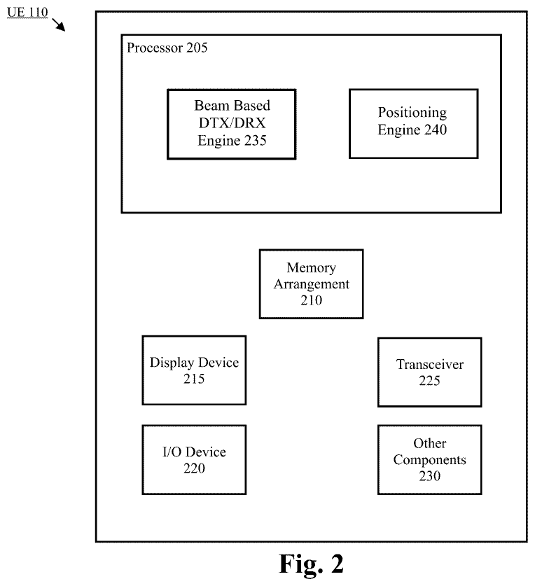

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a beam based DTX/DRX engine 235 for performing operations related to enhancing downlink coverage by supporting configurations for beam based DTX/DRX and obtaining beam based DTX/DRX information. The beam based DTX/DRX engine 235 may also support the UE performing additional operations in beam DTX and beam DRX, and for performing SIB-less operations, such as UE procedures in SIB-less operations, receiving and using configurations for SIB-less operations, and transmitting a wake-up signal to trigger SIB transmissions. The beam based DTX/DRX engine 235 may also perform operations related to receiving SIB1 and/or PRACH related information, receiving configuration information and/or activation signaling for applying a configuration for a given beam and performing operations on the beam in dependence on this information/signaling. Each of these example operations will be described in more detail below. The engines may also include a positioning engine 240 for transmitting positioning signals to each of a plurality of positioning nodes based on a network configuration for the positioning signals. The positioning signals are estimated by the positioning nodes to provide the network with information so that the network may determine a location of the UE, to be described in further detail below.

The above referenced engines 235 and 240 being applications (e.g., programs) executed by the processor 205 is only example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode, decode and/or process signals (e.g., signaling from a base station of a network) for implementing any one of the methods described herein.

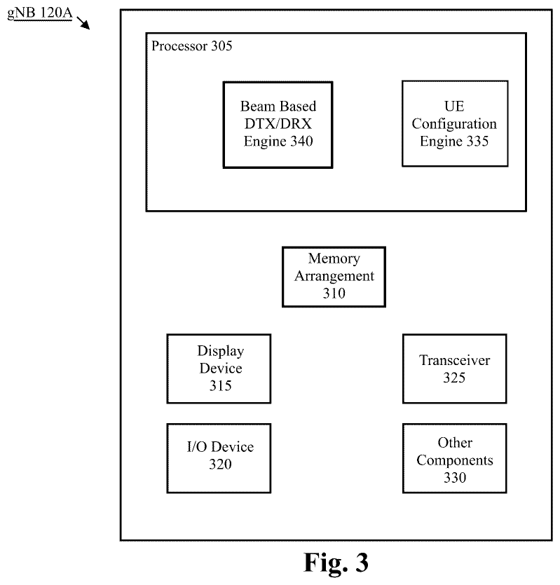

FIG. 3 shows an example base station 300 according to various example embodiments. The base station 300 may represent the gNB 120A, the gNB 120B or any other access node through which the UE 110 may establish a connection and manage network operations. It may be considered that the base station 300 is an anchor cell according to the present embodiments.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, when the gNB 120A is a serving cell for a UE, the engines may include a UE configuration engine 335 for providing UE configuration information to the network, for example, information relating to periods when the UE is in a DRX inactive mode or has a measurement gap (MG). The network may then distribute the information to positioning nodes so that the positioning nodes may monitor. The engines may also include a beam based DTX/DRX engine 340 for performing operations related to beam based DTX/DRX configuration and/or signaling. The beam based DTX/DRX engine 340 may also provide information to the UE for support the UE performing additional operations in beam DTX and beam DRX, and for performing SIB-less operations, such as UE procedures in SIB-less operations, receiving and using configurations for SIB-less operations, and transmitting a wake-up signal to trigger SIB transmissions. The beam based DTX/DRX engine 340 may also perform operations related to transmitting configuration information and/or activation signaling for applying a configuration for a given beam and performing operations on the beam in dependence on this information/signaling. The beam based DTX/DRX engine 340 may also be used for receiving the UE configuration information from the network and monitoring for positioning signals from the UE in accordance therewith. For example, the gNB 120A may determine a period during which it will monitor for the positioning signals and a period during which it will not monitor for the positioning signals based on the UE configuration information, to be described in further detail below, and estimate the positioning signals when it is received from the UE. Each of these example operations will be described in more detail below.

The memory arrangement 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode, decode and/or process signals (e.g., signaling from a UE) for implementing any one of the methods described herein.

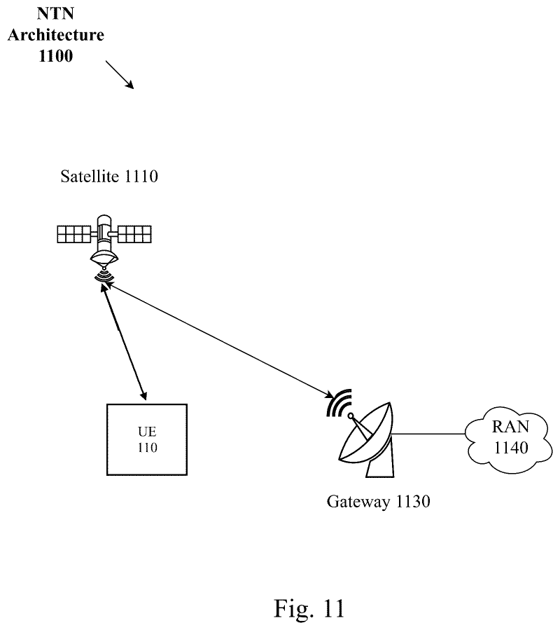

FIG. 11 shows an example non-terrestrial network (NTN) architecture 1100 according to various example embodiments. An NTN may relate to any network using non-terrestrial components, such as satellites, airplanes, unmanned aerial vehicles (UAVs), etc., to provide network services to UEs in the coverage area of the NTN.

The NTN architecture 1100 represents a network arrangement including one or more satellites, which in this example shows a single satellite 1110 that is integrated with a radio access network (RAN) 1140. The RAN 1140 may be, for example, the 5G NR RAN 120 described above with respect to FIG. 1. The NTN architecture 1100 includes a gateway 430 connecting the terrestrial network 1140 with the NTN components. In the NTN architecture 1100 of FIG. 11, the gateway 1130 and the satellite 1110 may communicate via feeder links. In some NTN deployments, satellites may be served by several gateways simultaneously.

The satellite provides network services to a UE 110 via a service link. The satellite 1110 may implement either a transparent payload or a regenerative payload. A transparent payload refers to an arrangement where the satellite 1110 may receive a signal and transmit an amplified version of the signal, with a frequency conversion. For example, the satellite 1110 may receive uplink communications from the UE 110 on service link frequencies and transmit an amplified version of the signal to the gateway 1130 on feeder link frequencies or may receive downlink communications via the gateway 1130 on feeder link frequencies and transmit an amplified version of the signal to the UE 110 on service link frequencies. A regenerative payload refers to an arrangement where the satellite 1110 acts as a distributed unit (DU) or a base station (e.g., a gNB), wherein received signals are regenerated with signal-processing techniques (e.g., demodulation, decoding, switching, encoding, modulation, etc.) before being re-transmitted.

With reference to FIG. 1, in a regenerative payload arrangement, the gNB 120A may be located on an aerial component, e.g., the satellite 1110 of FIG. 11. In a transparent payload arrangement, the gNB 120A may be located on the ground and the satellite 1110 is used to mirror the signals between the gNB 120A and the UE 110, as described above.

The example NTN architecture 1100 shown in FIG. 11 is not intended to limit the example embodiments in any way. NTNs may be integrated with the 5G NR RAN and/or other networks in any one of a variety of manners. For example, a typical satellite-based NTN may comprise a low earth orbit (LEO) constellation including an array of satellites and gateways with broad interconnectivity via ground-to-ground station (G2G) links, satellite-to-satellite (S2S) links, ground-to-satellite (G2S) links, and satellite-to-ground (S2G) links. Other types of satellite-based NTNs include geostationary-orbiting (GEO) satellites or medium-earth-orbiting (MEO) satellites.

As described above, the example embodiments are related to beam based discontinuous transmission/reception (DTX/DRX) for NTN. DL coverage enhancements may be considered at both the link level and the system level, at the link level to improve the link margin of selected physical channels to accommodate the EIRP reduction, and at the system level to support an efficient dynamic and flexible power sharing between beams or different beam pattern/size (i.e., wide or narrow) across the satellite foot print by leveraging techniques for network energy savings. The link level enhancements may include possible techniques such as increased repetition scheme or equivalent techniques depending on the physical channel. A link margin improvement for physical channels (e.g. physical downlink shared channel (PDSCH) and physical downlink control channel (PDCCH)) should be considered without impact on SSB design. At the system level, a total number of beams=1200 may be assumed for NGSO operating in FR1 band. This would correspond to the number of beams necessary to serve a satellite footprint at 30° min elevation with ˜50 km diameter beam size.

Operations for providing system information (SI) currently cause the network to consume a large amount of power. In Rel-15, the system information blocks (SIB) of a serving cell are transmitted on the serving cell itself. For FR2, up to 64 DL beams are deployed and each DL beam transmits its own SIB information in a beam sweeping manner, which causes a large amount of signaling overhead and power consumption. Further, uplink (UL) activity, particularly listening for random access (RACH) messages, may prevent the network from entering sleep modes deeper than micro sleep.

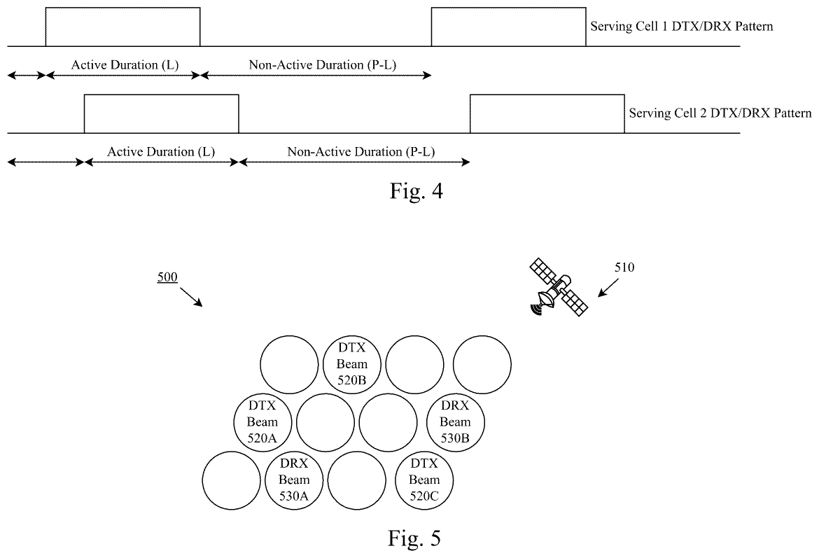

In network energy savings (NES) cell based DTX/DRX, a periodic cell DTX/DRX configuration is explicitly signaled to the UEs by UE specific Radio Resource Control (RRC) signaling. FIG. 4 shows an example cell based DTX/DRX configuration according to various example embodiments. The cell DTX/DRX was proposed for terrestrial networks. The cell DTX/DRX configuration is per serving cell, and contains at least: periodicity, start slot/offset, and on duration. Pattern configuration for cell DRX/DTX is common for Rel-18 UEs configured in the cell, with different DTX/DRX patterns for each cell. Notably, during the active duration periods, there is no NES. Separate DTX and DRX configuration may be configured. As a baseline, cell DTX/DRX is activated/deactivated implicitly by RRC signaling, i.e., activated immediately once configured by RRC and deactivated once the RRC configuration is released. Group common L1 signaling using PDCCH is also introduced for cell DTX/DRX activation and deactivation without hybrid automatic repeat request (HARQ) feedback. This was introduced due to benefits of signaling overhead reduction and more dynamic change than RRC, subject to UE capability.

For cell DTX, in Rel-18, the UE supporting cell DTX does not expect to receive and/or process the following, during non-active periods of cell DTX: periodic/semi-persistent (SPS) CSI-RS (channel state information-reference signal) configured in CSI report configuration in CSI-ReportConfig with reportQuantity including RI (for CSI reporting); PDCCHs associated with DCI format 2_0-DCI Format 2_5; PDCCH for dynamic grants/assignments for new transmissions; and SPS occasions. However, in cell DTX, the UE still monitors the following during non-active periods of cell DTX: PDCCH for Random Access Response (RAR) (Msg 2) and Msg 4; the PDCCH regardless of the Cell DTX when the retransmission timer is running (if C-DRX is configured); and physical downlink shared channel (PDSCH) scheduled by dynamic grant (DG) received.

In Rel-18, a UE supporting cell DRX is not expected to transmit the following, during non-active periods of cell DRX: periodic/semi-persistent CSI report; periodic/semi-persistent SRS (sounding reference signals) except for SRS positioning; configured grant (CG) occasions; scheduling request (SR) occasions overlapping with cell DRX non-active periods, e.g. SR transmissions are dropped during the non-active period; and if SR is not to be transmitted on an PUCCH (physical uplink control channel) occasion during cell DRX non-active time, the UE will keep the SR pending, i.e., the UE delays the SR transmission until the cell DRX active period without triggering RACH. However, for cell DRX, the UE still may transmit the following during non-active period of cell DRX: SRS for positioning; HARQ-ACK (hybrid automatic repeat request-acknowledgement) of a DG grant received; HARQ-ACK of SPS PDSCH transmitted; HARQ-ACK of a DCI format without scheduling a PDSCH; and physical uplink shared channel (PUSCH) scheduled by a DG grant received.

With the cell based DTX/DRX configuration discussed above, the UE may be expected to perform some operations during non-active periods of the cell DTX and cell DRX. Thus, there may still be issues with providing improved and accurate positioning performance without wasting resources, and there may be issues with maximizing the amount of NES. Thus, a mechanism is needed to be able to use NES systems that use DRX/DTX mechanisms to conserve power, while still providing improved and accurate positioning performance without wasting resources.

In order to enhance downlink coverage in NIN on a system level, it is proposed to modify the configurations to support partial, or beam based, DTX/DRX instead of cell DTX/DRX. This includes techniques and procedures for the UE to obtain beam based DTX/DRX. In addition, additional operations for UE in beam or cell DTX and beam or cell DRX are proposed, e.g., the UE's exception of operations for sidelink related scheduling and reporting in beam/cell DTX duration or beam/cell DRX duration. Further, SIB-less operations in NIN may be possible (where SIBs are not transmitted). That is, UE procedures in SIB-less operations in NIN and new configuration(s) for SIB-less operations are proposed, as well as a wake-up signal for the UE to trigger a SIB transmission, including triggering conditions and signaling design, to provide recovery from energy savings operations.

The above example techniques may be used together, used independently from one another, in conjunction with other currently implemented mechanisms for DTX/DRX, in conjunction with future implementations of DTX/DRX, and independently from other mechanisms for DTX/DRX.

In some example embodiments, a new configuration to provide for beam based DTX/DRX is introduced. FIG. 5 illustrates an example embodiment of a beam based DTX/DRX configuration. In the beam based DTX/DRX configuration 500, a satellite 510 may have a large area of coverage with many beams, with each beam covering a smaller area. The beams may be grouped together for DTX/DRX. For example, in one embodiment, beams 520A, 520B, and 520C may form one DTX beam based group, and beams 530A and 530B may form a DRX beam based group, where DTX or DRX may be implemented for energy savings. In some example embodiments, areas receiving some beams may be unlikely to contain a UE (e.g., areas in the middle of oceans), so these areas do not have to be served as often, or maybe at all. These areas (and corresponding beams) do not need to be served, which allows more power for the other beams.

A new configuration information element (IE) is introduced of beamDTXDRX-Config, which may include the following for each beam: BeamDTXDRX-onDurationTimer; BeamDTXDRX-CycleStartOffset; BeamDTXDRX-SlotOffset; BeamDTXDRXconfigType; and BeamDTXDRXactivationStatus. For each cell, there may be multiple beams. For the legacy cell based DTX/DRX, where there may be multiple beams per cell, the IE of cellDTXDRX-Config is composed of SEQUENCE (SIZE (1 . . . maxBeamofCell) of BeamDTXDRX-Config. It is possible to have multiple beams to form a beam group as discussed above and the IE of beamDTXDRX-Config is replaced by beamGroupDTXDRX-Config. The UE may be configured with a beam index or beam group index based on the beam the UE belongs to or is associated with. For beam based DTX/DRX, the IE of cellDTRX-DCI-Config may be kept, including: cellDTRX-RNTI RNTI-Value; sizeDCI-2-9 INTEGER (1 . . . 140); and positionInDCI-cellDTRX: INTEGER (0 . . . maxDCI-2-9-Size −1).

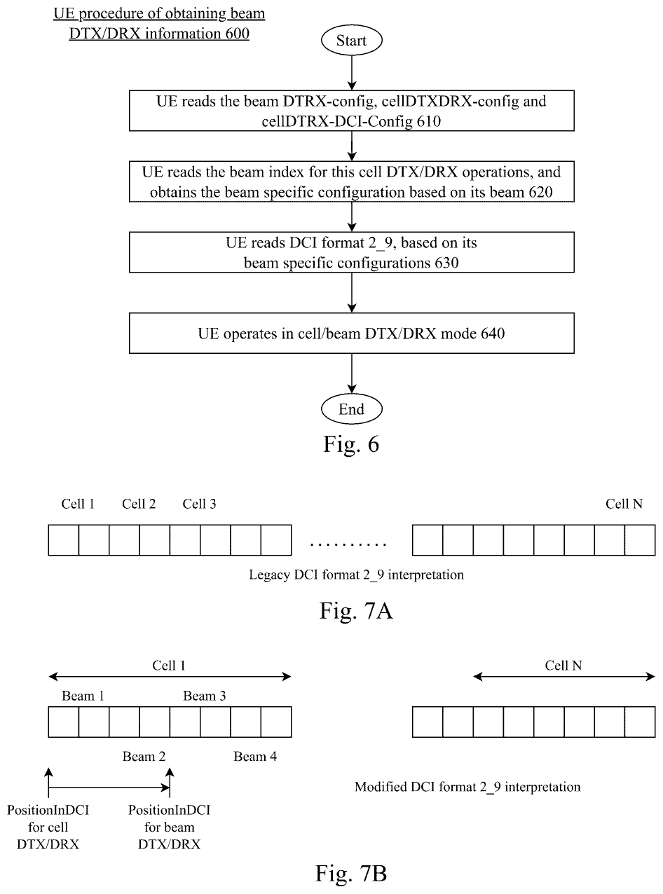

An example procedure for the UE to obtain beam DTX/DRX information is proposed. FIG. 6 is an example flow diagram illustrating an example procedure for the UE to obtain beam DTX/DRX information according to various example embodiments. The example procedure 600 includes the UE reading the configuration of cellDTXDRX-Config, which includes a list of beamDTXDRX-configuration, as well as cellDTRX-DCI-Config (610). This information may be sent to the UE via SIB or dedicated RRC message. The UE reads its beam index, which may be sent via dedicated RRC message or Medium Access Control Element (MAC CE), and from the beam index, obtains the beam specific configuration, which includes: BeamDTXDRX-onDurationTimer; BeamDTXDRX-CycleStartOffset; BeamDTXDRX-SlotOffset; BeamDTXDRXconfigType; and BeamDTXDRXactivationStatus (620). From the beam index, UE obtains the starting bit position in DCI 2-9 for its located beam (630). For example, if there are X beams (or beam groups) in a cell, and UE is in the Y-th beam (or beam groups) in a cell, then UE's starting bit position in DCI 2-9 is given by: (positionInDCI-cellDTRX+(Y−1)*2), if UE is configured with higher layer parameter for enabling both cell DTX and cell DRX; and (positionInDCI-cellDTRX+(Y−1)), otherwise. The UE reads the DCI format 2-9, and based on the obtained starting bit position for its located beam, the UE obtains the activation/deactivation of the beam DRX/DTX information and operates in cell DTX/DRX mode (640).

FIGS. 7A and 7B illustrate an example legacy DCI format 2_9 and an example modified DCI format 2_9 using the proposed beam based DTX/DRX configuration, respectively. The legacy DCI format 2_9 in FIG. 7A may be up to 140 bits and may cover multiple cells (cell 1 to cell N). Each cell has 2 bits, one for DTX and one for DRX, with a zero or one indicating whether DTX or DRX is activated or deactivated for that cell. The modified DCI format 2_9 in FIG. 7B may include multiple beams or multiple beam groups for each cell. For example, as seen in FIG. 7B, cell 1 has four beams in that embodiment.

DCI format 2_9 (Group Common DCI) is used for activating or de-activating the cell DTX/DRX configuration of one or multiple serving cells for one or more UEs. The following information may be transmitted using the DCI format 2_9 with CRC scrambled by NES-RNTI: block number 1, block number 2, . . . , block number N, where the starting position of a block is determined by the parameter positionInDCI-cellDTRX provided by higher layers for the UE. If multiple beams per cell for DTX/DRX is supported (or, beamDTXDRX-Config is configured), for the i-th beam in the cell, the beam starting position may be determined by positionInDCI-cellDTRX+2*(maxBeamsPercell)*(i−1), where maxBeamsPerCell is the maximum number of beams per cell. If the UE is configured with higher layer parameter XYZ, one or more blocks may be configured for the UE by higher layers, with the following field defined for each block: cell or beam DTX/DRX indication—2 bits if XYZ, with the MSB corresponding to cell DIX configuration and the LSB corresponding to cell DRX configuration; otherwise 1 bit. The size of DCI format 2_9 may be indicated by the higher layer parameter sizeDCI-2-9.

In addition, additional operations for the UE in beam or cell DTX and beam or cell DRX are proposed, e.g., the UE's exception of operations for sidelink related scheduling and reporting in beam/cell DTX duration or beam/cell DRX duration. For example, a UE may support beam/cell DTX, during non-active periods of beam/cell DTX (when the network is not transmitting). In some example embodiments, the UE may treat a sidelink grant in a similar way as a downlink grant. For example, the UE may not expect to receive and/or process the PDCCH for dynamic sidelink grants for new transmissions and monitors the PDCCH when the transmission timing is running. In other example embodiments, the UE may not treat any sidelink grant when the UE does not expect to receive and/or process the PDCCH for dynamic sidelink grants.

In other example embodiments, the UE may support beam/cell DRX, during non-active periods of beam/cell DRX (when the network is in DRX mode). In a first scenario, the UE may treat a sidelink grant in a similar way as a downlink grant. The UE may report sidelink HARQ-ACK of a received (either dynamic or configured) sidelink grant to a gNB. In another scenario, the UE may only report a sidelink HARQ-ACK of a received dynamic sidelink grant to the gNB, but does not report a sidelink HARQ-ACK of a configured sidelink grant. In yet another scenario, the UE may not report any sidelink HARQ-ACK to the gNB.

In addition, new UE procedures in SIB-less operations in NTN and new configuration(s) for SIB-less operations are proposed, as well as a wake-up signal for the UE to trigger the SIB transmission, including triggering conditions and signaling design. Before discussing the proposed new procedures and configurations for SIB-less configurations, some background on SIB-less operations is provided.

The 5G NR initial access procedure generally comprises the following operations. However, this example is provided only for illustrating particular aspects of a generic 5G NR initial access procedure as they relate to the example embodiments. Other access procedures may be used according to existing or future 5G NR specifications. The example embodiments are not limited to any particular access procedure or order of operations. Further, various aspects of the procedure described below are applicable to scenarios other than initial access. Accordingly, the example embodiments are not limited to the following example initial access procedure.

A base station (e.g., gNB) periodically broadcasts system information (SI), which may be categorized as minimum system information (MSI) and other system information (OSI), using beam sweeping. Beam sweeping generally refers to the transmission of a plurality of transmitter beams over a particular spatial area over a predetermined duration at some predetermined periodicity. Each beam transmitted during a transmitter beam sweep may include a reference signal. A UE may measure one or more of the transmitter beams based on the respective reference signals and select one of the transmitter beams based on the measurement data.

A transmitter beam broadcast by the gNB in the beam sweeping operation may include a synchronization signal block (SSB) comprising synchronization signals (SS) (a primary synchronization signal (PSS) and a secondary synchronization signal (SSS)) and a physical broadcast channel (PBCH), where the PBCH transmission includes a master information block (MIB) containing MSI. The MSI includes parameters indicating the location and resources for Control Resource Set 0 (CORESET #0) on the resource grid, which carries the downlink control information (DCI) used to decode system information block 1 (SIB1). In particular, the parameter PDCCHConfigSIB1, transmitted in the MIB, has a length of 8 bits, with the first 4 bits (most significant bits (MSBs)) determining the “controlResourceSetZero” index, which indicates the number of resource blocks/symbols used to determine the CORESET #0 of the type0 PDCCH Common Search Space. The last 4 bits (least significant bits (LSB)) determine the “searchSpaceZero” Index, which indicates the PDCCH Monitoring Occasions.

The DCI on CORESET #0 is used to decode SIB1 on the PDSCH. SIB1 may be referred to as remaining minimum system information (RMSI), a subset of MSI, and is carried on the PDSCH. The SSB (including the MIB) and the CORESET #0/RMSI (SIB1) are transmitted on a same beam, which, when selected by the UE, will be used by the UE for random access channel (RACH) transmissions until a dedicated connection is established and the beam is switched. OSI includes further SIBs (e.g., SIB2, SIB3, etc.), which may be broadcast or provisioned for the UE via dedicated RRC signaling.

Thus, for initial access purposes, the UE performs beam measurements, detects the best SSB (e.g., the strongest beam) and selects this beam. The UE then decodes the SSB and, based on the extracted MSI parameters, searches the Type0-PDCCH common search space (CSS) for downlink control information (DCI) on the CORESET #0, which is then used to decode SIB1. The extracted SI allows the UE to use the same beam to initiate the random access (RACH procedure) by transmitting Msg1 of the RACH procedure, i.e., the RACH preamble, on the physical random access channel (PRACH). The gNB listens for the RACH preamble (Msg1) and, when detected, transmits a random access response (RAR) (Msg2) on the PDSCH to provide additional information to continue the access procedure. A dedicated connection is ultimately established, at which time the UE and the gNB may switch to a different beam.

As described above, the beam sweeping operation for providing SI consumes a large amount of power. Additionally, listening for RACH may prevent a serving cell from entering deep sleep modes, e.g., under low load conditions such as late night and early morning.

According to various example embodiments described herein, new UE procedures in SIB-less operations in NIN and new configuration(s) for SIB-less operations are proposed, as well as a wake-up signal for the UE to trigger the SIB transmission, including triggering conditions and signaling design. In some aspects, network signaling may be reduced and/or otherwise adapted with regard to transmitting system information blocks (SIBs). The UE may use the wake-up signal when information is needed by the UE. For example, the UE may use updated satellite location information, which is provided in SIB19.

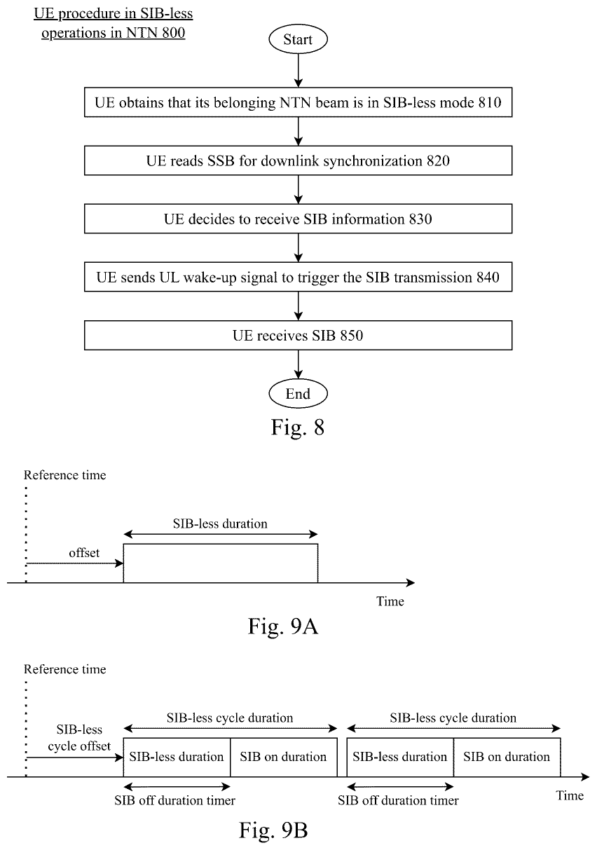

FIG. 8 is an example flow diagram illustrating an example procedure for a UE in SIB-less operations in a NTN according to various example embodiments. Referring to FIG. 8, in an example procedure 800, the UE obtains information indicating that a beam (e.g., a NTN beam) is received while in SIB-less mode (810). That is, the network has not transmitted a SIB for this particular beam. This information may be carried in a dedicated RRC message or in a SIB (e.g., SIB1 or SIB19). An example configuration for SIB-less may include SIB-less timing information. In some example embodiments, this may be a one-time configuration which includes a starting time of SIB-less mode. FIG. 9A is an example configuration for a one-time configuration for SIB-less timing information according to various example embodiments. In FIG. 9A, the starting time may be a reference time (e.g., SFN=0, or configuration signaling time) and an offset from the reference time. The one-time configuration may also include a duration of the SIB-less mode. No SIBs are sent during the SIB-less duration period.

In other example embodiments, the configuration for SIB-less may be a periodic configuration. FIG. 9B is an example configuration for a periodic configuration for SIB-less timing information according to various example embodiments. In FIG. 9B, the periodic configuration may include SIB-less cycle information and SIB off duration. The SIB-less cycle information may include a reference time (e.g., SFN (system Frame Number)=0, or configuration signaling time), a cycle start offset from the reference time, and a cycle duration. In some example embodiments, no SIBs may be sent during the various SIB-less duration (SIB off) periods. In other example embodiments, most SIBs are not sent during the various SIB-less duration (SIB off) periods, but a select few SIBs may be sent.

There may also be a list of SIBs which will not be sent. In some example embodiments, this list may be sent to the UE by the network. For example, SIB19 may be always on, which includes common TA information and ephemeris information for the UE's uplink synchronization.

Referring back to FIG. 8, after the UE knows it is in SIB-less mode, the UE may detect a SSB and reads the SSB for downlink synchronization (820). At some point, the UE makes a determination to receive SIB information (830). For example, the UE may need some information to measure a neighboring cell. The UE may transmit a UL wake-up signal to trigger the SIB transmission (840). Once the UL wake-up signal has been transmitted, the UE may receive a SIB (850). Triggering conditions for the transmission of the UL wake-up signal may include one or more of the following: a need for ephemeris information and common time information and to see if they are still valid; the UE has uplink data to transmit; and the UE has just moved to an area with the beam, so the UE does not have the SIB-less configuration. In some example embodiments, the UL wake-up signal may include a payload including a list of SIBs to be transmitted and their transmission time, and the SIB transmission mode. The SIB transmission mode may be a one-time broadcast in one example, where the gNB moves back to SIB-less mode after the broadcast. In another example, it may be a keep-on broadcast (continuous), where the gNB continues broadcasting SIB as in normal mode.

There are several options for a container for the UL wake-up signal: PRACH, PUCCH with specific SR, or a new channel or signal. In the PRACH embodiment, dedicated RACH occasions or dedicated PRACH preambles are used to indicate the triggering of SIB broadcast. Different RACH occasions or PRACH preambles may be used to indicate SIB transmission mode and/or the list of SIB to be transmitted. In some example embodiments, a single dedicated PRACH preamble may be used as a no-contention PRACH. In the PUCCH with specific SR embodiment, a specific scheduling request may be used for SIB transmissions. In the new channel or signal embodiment, a single low-PAPR (Peak-to-Average Power Ratio) sequence on dedicated resources may be employed.

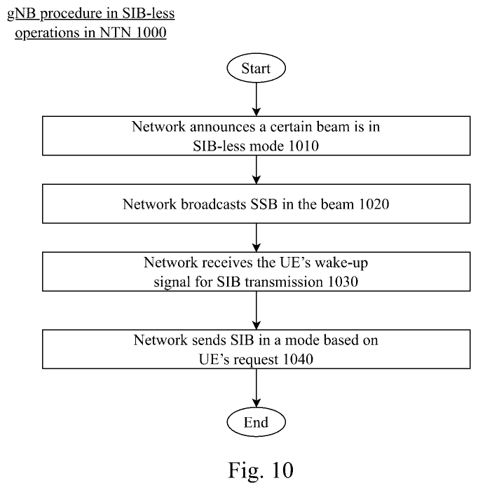

On the network side, a base station, such as gNB 120A, may be involved to assist the UE in the SIB-less operations. FIG. 10 is a flow chart for an example procedure for a gNB in SIB-less operations according to various example embodiments. In example procedure 1000, a network (such as via a gNB) announces a certain beam is in SIB-less mode (1010). The network may broadcast SSB(s) in the beam (1020). At some point after sending the SSB(s) in the beam, the gNB may receive a wake-up signal for SIB transmission from a UE (1030). The gNB may then send SIB in a mode based on the UE's request (1040).

By using the proposed configurations to support beam based DTX/DRX, and the techniques and procedures for the UE to obtain beam based DTX/DRX, downlink coverage may be enhanced in NTNs on a system level. In addition, additional operations for UE in beam or cell DTX and beam or cell DRX may be performed for increased efficiency, e.g., the UE's exception of operations for sidelink related scheduling and reporting in beam/cell DTX duration or beam/cell DRX duration. Further, using the embodiments disclosed herein, it may be possible to perform SIB-less operations in NIN may be possible, thereby further increasing energy savings.

### EXAMPLES

In a first example, a method, comprising, processing, based on signals received from a network, beam based configuration information, where the beam based configuration information comprises configuration information for one or more individual beams received by a user equipment (UE) and operating in a discontinuous transmission (DTX) mode and/or a discontinuous reception (DRX) mode using the beam based configuration information.

In a second example, the method of the first example, wherein the beam based configuration information comprises an information element of beamDTXDRX-Config, which comprises, for each beam, one or more of: BeamDTXDRX-onDurationTimer; BeamDTXDRX-CycleStartOffset; BeamDTXDRX-SlotOffset; BeamDTXDRXconfigType; and BeamDTXDRXactivationStatus.

In a third example, the method of the second example, wherein the beam based configuration information comprises configuration information for multiple beams received by the UE.

In a fourth example, the method of the third example, further comprising processing, based on signals received from a network, cell based configuration information, and wherein the cell based configuration information comprises an information element of cellDTXDRX-Config, which comprises SEQUENCE (SIZE (1 . . . maxBeamofCell) of BeamDTXDRX-Config.

In a fifth example, the method of the first example, wherein the beam based configuration information comprises configuration information for multiple beams received by the UE and multiple beams are grouped to form a beam group.

In a sixth example, the method of the fifth example, wherein the beam based configuration information comprises an information element of beamGroupDTXDRX-Config.

In a seventh example, the method of the fifth example, wherein the beam based configuration information comprises a beam group index based on the beam group associated with the UE.

In an eighth example, the method of the first example, wherein the beam based configuration information comprises a beam index based on the beam associated with the UE.

In a ninth example, the method of the eighth example, further comprising processing, based on signals received from a network, cell based configuration information comprising a list of beam based DTX/DRX configurations and downlink control information (DCI) format 2_9 and obtaining, from the beam index, beam specific configuration information.

In a tenth example, the method of the ninth example, wherein the list of beam based DTX/DRX configurations is transmitted to the UE via system information blocks (SIB) or a dedicated Radio Resource Control (RRC) message.

In an eleventh example, the method of the ninth example, wherein the beam index is transmitted to the UE via a dedicated Radio Resource Control (RRC) message or a Medium Access Control Element (MAC CE).

In a twelfth example, the method of the ninth example, wherein the beam specific configuration information comprises, for each beam, one or more of: BeamDTXDRX-onDurationTimer; BeamDTXDRX-CycleStartOffset; BeamDTXDRX-SlotOffset; BeamDTXDRXconfigType; and BeamDTXDRXactivationStatus.

In a thirteenth example, the method of the ninth

example, wherein the processing circuitry is further configured to obtain a starting bit position in the DCI format 2_9 based on the beam index.

In a fourteenth example, the method of the thirteenth example, wherein if there are X beams (or beam groups) in a cell, and the UE is in the Y-th beam (or beam group) in a cell, then the starting bit position for the UE in DCI 2-9 is given by: (positionInDCI-cellDTRX+(Y−1)*2), if the UE is configured with a higher layer parameter for enabling both cell DTX and cell DRX; and (positionInDCI-cellDTRX+(Y−1)) if not.

In a fifteenth example, the method of the thirteenth example, further comprising obtaining activation/deactivation information of the beam DRX/DTX based on the obtained starting bit position an operating in DTX mode and/or DRX mode based on the activation/deactivation information.

In a sixteenth example, the method of the thirteenth example, wherein the cell based configuration information comprises a parameter positionInDCI-cellDTRX for determining the starting position of a block, and wherein if multiple beams per cell for DTX/DRX is supported or if beamDTXDRX-Config is configured, the processing circuitry is further configured to determine a beam starting position for an i-th beam in the cell by positionInDCI-cellDTRX+2*(maxBeamsPercell)*(1−1), where maxBeamsPerCell is the maximum number of beams per cell.

In a seventeenth example, the method of the first example, wherein the processing circuitry is further configured to support DTX during non-active periods of DTX where the network is not transmitting by treating one or more sidelink grants in a similar way as downlink grants.

In an eighteenth example, the method of the seventeenth example, wherein the UE does not expect to receive or process a physical downlink control channel (PDCCH) for dynamic sidelink grants for new transmissions.

In a nineteenth example, the method of the seventeenth example, further comprising monitoring a physical downlink control channel (PDCCH) when transmission timing is running.

In a twentieth example, the method of the first example, further comprising supporting DTX during non-active periods of DTX by not treating any sidelink grants when the UE does not expect to receive or process a physical downlink control channel (PDCCH) for dynamic sidelink grants.

In a twenty first example, the method of the first example, further comprising supporting DRX during non-active periods of DRX where the network is not receiving by treating one or more sidelink grants in a similar way as downlink grants.

In a twenty second example, the method of the twenty first example, further comprising generating, for transmission to base station, signals reporting a sidelink hybrid automatic repeat request-acknowledgement (HARQ-ACK) of a received sidelink grant, wherein the received sidelink grant is a dynamic grant or a configured grant.

In a twenty third example, the method of the first example, further comprising supporting DRX during non-active periods of DRX where the network is not receiving by causing transceiver circuitry to transmit signals reporting a sidelink hybrid automatic repeat request-acknowledgement (HARQ-ACK) of a received dynamic sidelink grant to a base station, but not causing the transceiver circuitry to transmit signals reporting a sidelink HARQ-ACK of a configured sidelink grant to the base station.

In a twenty fourth example, the method of the first example, further comprising supporting DRX during non-active periods of DRX where the network is not receiving by not reporting any sidelink hybrid automatic repeat request-acknowledgement (HARQ-ACK) to a base station.

In a twenty fifth example, the method of the first example, further comprising receiving one or more beams from a satellite in a non-terrestrial network (NTN).

In a twenty sixth example, a processor configured to perform any of the methods of the first through twenty fifth examples.

In a twenty seventh example, a user equipment (UE) configured to perform any of the methods of the first through twenty fifth examples.

In a twenty eighth example, a method, comprising processing, based on signals received from a base station, configuration information comprising information indicating that one or more beams received by a user equipment (UE) is in a mode where system information blocks (SIBs) are not being transmitted (SIB-less mode), determining, based on a trigger, that SIB information is used and generating, for transmission to the base station, an uplink wake-up signal to request a SIB transmission.

In a twenty ninth example, the method of the twenty eighth example, further comprising receiving one or more beams from a satellite in a non-terrestrial network (NTN).

In a thirtieth example, the method of the twenty eighth example, further comprising detecting synchronization signal block (SSB) information in the one or more beams.

In a thirty first example, the method of the twenty eighth example, further comprising receiving the SIB transmission from the base station.

In a thirty second example, the method of the twenty eighth example, wherein the configuration information is transmitted via dedicated Radio Resource Control (RRC) message or in a system information block (SIB).

In a thirty third example, the method of the twenty eighth example, wherein the configuration information comprises SIB-less timing information.

In a thirty fourth example, the method of the thirty third example, wherein the SIB-less timing information is a one-time configuration which includes a starting time of SIB-less mode and a duration of the SIB-less mode, wherein the starting time is based on a reference time and an offset from the reference time.

In a thirty fifth example, the method of the thirty third example, wherein the SIB-less timing information is a periodic configuration which includes SIB-less cycle information and a SIB off duration time, wherein the SIB-less cycle information comprises a reference time, a cycle start offset from the reference time, and a cycle duration and wherein no SIBs are sent during the SIB off duration time.

In a thirty sixth example, the method of the thirty third example, wherein the configuration information comprises a list of SIBs which will not be sent.

In a thirty seventh example, the method of the twenty eighth example, wherein the trigger comprises one or more of: a need for ephemeris information and common time information and to see if the ephemeris information and common time information are still valid, the UE has uplink data to transmit, and the UE has just moved to an area with the received one or more beams, so the UE does not have the configuration information indicating the SIB-less mode.

In a thirty eighth example, the method of the twenty eighth example, wherein the uplink wake-up signal comprises a payload, the payload including a list of SIBs to be transmitted and their transmission time, and a SIB transmission mode.

In a thirty ninth example, the method of the thirty eighth example, wherein the SIB transmission mode is a one-time broadcast from the base station, where the base station returns to SIB-less mode after the one-time broadcast.

In a fortieth example, the method of the thirty eighth example, wherein the SIB transmission mode is a keep-on continuous broadcast from the base station, where the base station is configured to keep on broadcasting SIB as in normal mode.

In a forty first example, the method of the twenty eighth example, wherein the uplink wake-up signal is transmitted via a physical random access channel (PRACH).

In a forty second example, the method of the forty first example, wherein dedicated random access channel (RACH) occasions or dedicated PRACH preambles are used to indicate triggering of the SIB transmission, with different RACH occasions or PRACH preambles used to indicate a SIB transmission mode and/or the list of SIBs to be transmitted.

In a forty third example, the method of the forty first example, wherein a single dedicated PRACH preamble is used as a no-contention PRACH.

In a forty fourth example, the method of the twenty eighth example, wherein the uplink wake-up signal is transmitted via a physical uplink control channel (PUCCH) with a specific scheduling request for SIB transmissions.

In a forty fifth example, the method of the twenty eighth example, wherein the uplink wake-up signal is transmitted via a new channel, wherein the new channel is a single low-PAPR (Peak-to-Average Power Ratio) sequence on dedicated resources.

In a forty sixth example, a processor configured to perform any of the methods of the twenty eighth through forty fifth examples.

In a forty seventh example, a user equipment (UE) configured to perform any of the methods of the twenty eighth through forty fifth examples.

In a forty eighth example, a method, comprising determining that one or more beams configured to be received by a user equipment (UE) is in a mode where system information blocks (SIBs) are not being transmitted (SIB-less mode), generating, for broadcast, synchronization signal block (SSB) information in the one or more beams, processing, based on signals received from the UE, a wake-up indication for SIB transmission, the wake-up indication comprising a request for SIB information and generating, for transmission in a transmission mode based on the request, the requested SIB information.

In a forty ninth example, the method of the forty eighth example, wherein the one or more beams are sent by a satellite in a non-terrestrial network (NTN).

In a fiftieth example, a processor configured to perform any of the methods of the forty eighth through forty ninth examples.

In a fifty first example, a base station configured to perform any of the methods of the forty eighth through forty ninth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
process, based on signals received from a network, beam based configuration information, where the beam based configuration information comprises configuration information for one or more individual beams received by a user equipment (UE); and
operate in a discontinuous transmission (DTX) mode and/or a discontinuous reception (DRX) mode using the beam based configuration information.

2. The apparatus of claim 1, wherein the beam based configuration information comprises an information element of beamDTXDRX-Config, which comprises, for each beam, one or more of: BeamDTXDRX-onDurationTimer; BeamDTXDRX-CycleStartOffset; BeamDTXDRX-SlotOffset; BeamDTXDRXconfigType; and BeamDTXDRXactivationStatus.

3. The apparatus of claim 2, wherein the beam based configuration information comprises configuration information for multiple beams received by the UE.

4. The apparatus of claim 3, wherein the processing circuitry is further configured to process, based on signals received from a network, cell based configuration information, and wherein the cell based configuration information comprises an information element of cellDTXDRX-Config, which comprises SEQUENCE (SIZE (1 . . . maxBeamofCell) of BeamDTXDRX-Config.

5. The apparatus of claim 1, wherein the beam based configuration information comprises configuration information for multiple beams received by the UE and multiple beams are grouped to form a beam group.

6. The apparatus of claim 5, wherein the beam based configuration information comprises an information element of beamGroupDTXDRX-Config.

7. The apparatus of claim 5, wherein the beam based configuration information comprises a beam group index based on the beam group associated with the UE.

8. The apparatus of claim 1, wherein the beam based configuration information comprises a beam index based on the beam associated with the UE.

9. The apparatus of claim 8, wherein the processing circuitry is further configured to:
process, based on signals received from a network, cell based configuration information comprising a list of beam based DTX/DRX configurations and downlink control information (DCI) format 2_9; and
obtain, from the beam index, beam specific configuration information.

10. The apparatus of claim 9, wherein the processing circuitry is further configured to obtain a starting bit position in the DCI format 2_9 based on the beam index.

11. The apparatus of claim 1, wherein the processing circuitry is further configured to support DTX during non-active periods of DTX where the network is not transmitting by treating one or more sidelink grants in a similar way as downlink grants.

12. The apparatus of claim 1, wherein the processing circuitry is further configured to support DTX during non-active periods of DTX by not treating any sidelink grants when the UE does not expect to receive or process a physical downlink control channel (PDCCH) for dynamic sidelink grants.

13. The apparatus of claim 1, wherein the processing circuitry is further configured to support DRX during non-active periods of DRX where the network is not receiving by treating one or more sidelink grants in a similar way as downlink grants.

14. The apparatus of claim 1, wherein the processing circuitry is further configured to support DRX during non-active periods of DRX where the network is not receiving by causing transceiver circuitry to transmit signals reporting a sidelink hybrid automatic repeat request-acknowledgement (HARQ-ACK) of a received dynamic sidelink grant to a base station, but not causing the transceiver circuitry to transmit signals reporting a sidelink HARQ-ACK of a configured sidelink grant to the base station.

15. The apparatus of claim 1, wherein the processing circuitry is further configured to support DRX during non-active periods of DRX where the network is not receiving by not reporting any sidelink hybrid automatic repeat request-acknowledgement (HARQ-ACK) to a base station.

16. An apparatus comprising processing circuitry configured to:
process, based on signals received from a base station, configuration information comprising information indicating that one or more beams received by a user equipment (UE) is in a mode where system information blocks (SIBs) are not being transmitted (SIB-less mode);
determine, based on a trigger, that SIB information is used; and
generate, for transmission to the base station, an uplink wake-up signal to request a SIB transmission.

17. The apparatus of claim 16, wherein the processing circuitry is further configured to detect synchronization signal block (SSB) information in the one or more beams.

18. The apparatus of claim 16, wherein the processing circuitry is further configured to receive the SIB transmission from the base station.

19. The apparatus of claim 16, wherein the configuration information is transmitted via dedicated Radio Resource Control (RRC) message or in a system information block (SIB).

20. The apparatus of claim 16, wherein the configuration information comprises SIB-less timing information.
